(19) United States
(12) Patent Application Publication
(10) Pub. No.: US 2011/0153453 A1
(43) Pub. Date: Jun. 23, 2011

(54) TRANSPORT ALLOCATION AND PAYMENT SYSTEM, METHOD AND SOFTWARE

(76) Inventors: Gameelah Ghafoor, Dundee (GB); Richard Douglas Lawson, Dundee (GB)

(21) Appl. No.: 12/641,582

(22) Filed: Dec. 18, 2009

(51) Int. Cl. G06Q 50/00; G05B 19/00; G06Q 30/00; G06F 17/00; G06F 3/048

(52) U.S. Cl. 705/26.9; 340/5.9; 701/300; 715/764

(57) ABSTRACT

A system and method whereby a customer requiring hire of a taxi can view available taxis on their mobile phone and can select a taxi for hire. An authorisation of payment is carried out and the selected taxi allocated to the customer if the authorisation is successful.

### FIELD OF THE INVENTION

The present invention relates to a transport allocation and payment system, method and software. More particularly, but not exclusively, the invention relates to a transport allocation and payment system, method and software for selecting preferred transport on a geographical basis.

### BACKGROUND TO THE INVENTION

Currently, when a prospective customer wishes to order a taxi they must either hail one that is passing, or alternatively they can book a taxi over the telephone.

Both of these situations leave the taxi driver with possible non-payment issues, in both instances the customer who uses the taxi may not have sufficient funds to pay for their journey, and where the taxi is booked over the telephone via a control centre, the customer may not be at the location where they booked the taxi to collect them and thus without their expected fare.

Additionally, when a customer books the taxi over the telephone the control centre attempts to optimise the customer to taxi distance so as to minimise the customer's waiting time. However, this is procedure is not always optimal, which can result in increased waiting times for customer's, and decreased customer satisfaction.

Furthermore, neither of the above situations provides security to the customer as they have no guarantee that the “taxi” that arrives to collect them is in fact a licensed taxi and could be an unlicensed vehicle, leaving the customer subject to overcharging and even possibly physical attack.

### SUMMARY OF THE INVENTION

According to a first aspect of the present invention there is provided a transport allocation and payment system comprising:

a plurality of vehicles, each comprising a positional locator and a transceiver;
a base station comprising a transceiver and a server;
a user device comprising a processor, a transceiver, a display and a user interface;
the positional locator of each vehicle being arranged to transmit the location of each vehicle to the base station using the vehicle's transceiver;
the base station being arranged to receive the location of each vehicle via the base station's transceiver and to update a positional database stored on the server;
the user device being arranged to receive a request for transport from a user via a user interface and to transmit said request and the location of the user device to the server of the base station via the user device's transceiver;
the base station being arranged to transmit data corresponding to the locations of at least some of the plurality of vehicles to the user device;
the user device being arranged to display the location of the at least some of the plurality of vehicles on the display;
the user interface being arranged to receive a user input indicative of which one of the at least some of the plurality of vehicles the user wishes to hire;
the user device being arranged to transmit data corresponding to the user input to the base station; and
the base station being arranged to transmit the data corresponding to the user input to the one of the plurality of vehicles.

Such a system allows a customer to request, for example, a taxi and have details of those taxis in their locale forwarded to them so that they can select which taxi they wish to hire.

The base station may comprise a database containing details of registered users of the system and may be arranged to request authorisation of a payment from a user's account in response to receiving the data corresponding to the user input. The base station may be arranged to prevent transmission of the data corresponding to the user input to the one of the plurality of vehicles if authorisation of the payment is refused.

The pre-authorisation of payment for the hire of a vehicle ensures that the hire company, and consequently the driver, receive payment even in the event of a customer taking hiring another passing vehicle for hire or in the event of a malicious hire request. Also, the refusal of a hire request if the customer does not have sufficient funds to pay a hire fee reduces the likelihood of the hire company, and driver, not receiving payment for a hire.

The user interface may be arranged to allow entry of data corresponding to the user's location. The user device may comprise a locator arranged to determine the location of the user device. The base station may be arranged to determine which of the plurality vehicles are located within a pre-determined distance of the location of the user device. The base station may be arranged to transmit data corresponding to the location of only those of the plurality of vehicles which are located within the pre-determined distance to the user device.

This prevents the customer receiving details of vehicles which are a long distance away from them.

One of the plurality of vehicles may comprise a driver interface unit arranged to display details of the user who has selected said vehicle. The driver interface unit may be arranged to receive a driver input either declining or accepting the user as a passenger. The vehicle's transceiver may be arranged to transmit data corresponding to the driver input to the base station. The base station may be arranged to transmit data corresponding to the driver input to the user device, where the contents of said data are displayed at the user interface. The base station may be arranged to change a status flag of said vehicle in response to the contents of the data corresponding to the driver input. The base station may be arranged to transmit data relating to only those of the plurality of vehicles to the user device which have a status flag corresponding to being available for hire.

Such an operation allows the driver to decline a fare, and the customer to select another vehicle if the driver declines the fare. Also, selective transmission of data relating to only those vehicles which are available for hire means that the customer does not attempt to hire a vehicle which is already unavailable.

At least some of the plurality of vehicles may be taxis.

According to a second aspect of the present invention there is provided a method of transport allocation and payment comprising the steps of

transmitting the location of each of a plurality of vehicles to a base station using a respective transceiver of each of the plurality of vehicles;
receiving the location of at least one of the plurality of vehicles via a transceiver at a base station;
updating a positional database stored on a server of the base station;
receiving a request for transport from a user at a user device via a user interface;
transmitting the request and the location of the user device to the server of the base station via a transceiver of the user device;
transmitting data corresponding to the locations of at least some of the plurality of vehicles from the base station to the user device;
display the location of the at least some of the plurality of vehicles on a screen of the user device;
receiving a user input indicative of which one of the at least some of the plurality of vehicles the user wishes to hire at the user interface;
transmitting data corresponding to the user input to the base station from the user device; and
transmitting the data corresponding to the user input to the one of the plurality of vehicles from the base station.

The base station may comprise a database containing details of registered users of the system. The method may comprise requesting authorisation of a payment from a user's account in response to receiving the data corresponding to the user input. The method may comprise preventing transmission of the data corresponding to the user input to the one of the plurality of vehicles from the base station if authorisation of the payment is refused.

The method may comprise allow entry of data corresponding to the user's location at the user interface. The method may comprise determining the location of the user device using a locator device. The method may comprise determining which of the plurality vehicles are located within a pre-determined distance of the location of the user device, at the base station. The method may comprise transmitting data corresponding to the location of only those of the plurality of vehicles which are located within the pre-determined distance to the user device from the base station.

The method may comprise receiving a driver input either declining or accepting the user as a passenger at a driver interface unit. The method may comprise transmitting data corresponding to the driver input to the base station via the vehicle's transceiver. The method may comprise transmitting data corresponding to the driver input to the user device, where the contents of said data are displayed at the user interface. The method may comprise changing a status flag of said vehicle in response to the contents of the data corresponding to the driver input. The method may comprise transmitting data relating to only those of the plurality of vehicles which have a status flag corresponding to being available for hire from the base station to the user device.

At least some of the plurality of vehicles may be taxis.

According to a third aspect of the present invention there is provided a mobile device software application which when executed upon a processor of the mobile device causes the mobile device to operate as the user device of the first aspect of the present invention.

According to a fourth aspect of the present invention there is provided base station software which when executed upon a processor of the base station causes the base station to operate as the base station of the first aspect of the present invention.

According to a fifth aspect of the present invention there is provided a mobile device arranged to operate as the user device of the first aspect of the present invention.

According to a sixth aspect of the present invention there is provided a vehicle hire base station arranged to operate as the base station of the first aspect of the present invention.

According to a seventh aspect of the present invention there is provided a mobile device software application arranged to generate and display a graphical user interface (GUI) on the user device of the first aspect of the present invention wherein the GUI corresponds to the user interface of the first aspect of the present invention.

### BRIEF DESCRIPTION OF THE DRAWINGS

Embodiments of the present invention will now be described, by way of example only, with reference to the accompanying drawings, in which:

FIG. 1 is a schematic diagram of a transport allocation and payment system according an aspect of the present invention; and

FIG. 2 is a flowchart detailing a method of transport allocation and payment according to another aspect of the present invention.

### DETAILED DESCRIPTION

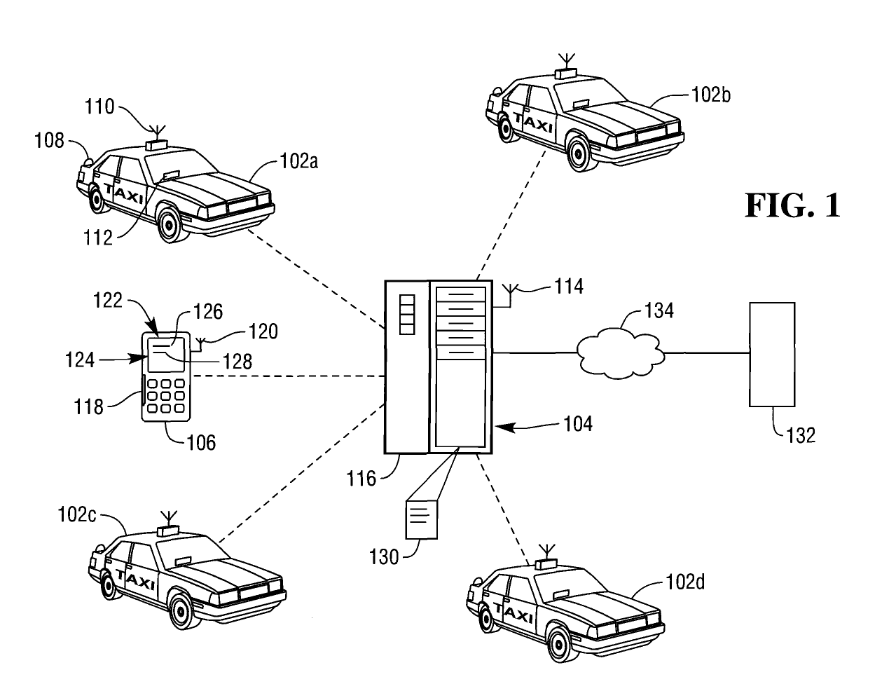

Referring now to FIG. 1 a transport allocation and payment system 100 comprises a fleet of vehicles, for example taxis 102a-d, a base station 104 and a user device, for example a mobile telephone 106.

Each taxi 102a-d, each comprises a positional locator device 108, typically a global positioning system (GPS) device, a transceiver 110 and a driver interface unit 112.

The base station 104 comprises a transceiver 114 and a server 116.

The mobile telephone 106 comprises a processor 118, a transceiver 120, a display 122 and a user interface 124. Typically, the user interface 124 comprises a graphical user interface (GUI) 126 displayed on the display and a touch screen 128 overlaying the display 122.

The positional locator device 108 of each taxi 102a-d transmits the location of each vehicle to the base station 104 using the taxi's transceiver 110. The base station 104 receives the location of each taxi 102a-d via the base station's transceiver 114 and to update a positional database 130 stored on the server 116 to reflect any change in the location of any of the taxis 102a-d.

A customer requiring hire of a taxi 102a-d inputs a request at the mobile telephone 106 via the user interface 124. The mobile telephone 106 transmits the request and the location of the mobile telephone 106 to the server 116 base station 104 via the mobile telephone's transceiver 114. The location of the mobile telephone 106 can be either determined from a locator device, typically a GPS device, in the mobile telephone 106 or by the customer entering their location via the user interface 124. In response to receiving the request from mobile telephone 106 the base station 104 transmits data corresponding to the locations some of the taxis 102a-d to the mobile telephone 106. Usually, the base station 104 applies a filter to data relating to the taxis 102a-d, for example only forwarding data relating to taxis 102a-d that are within a particular distance of the mobile telephone 106, this distance may vary according to the location of the mobile telephone 106, for example the distance may be a 1 km radius in an urban area or up to a 10 km radius in a rural area. Such a variation of the filtered distance can be achieved by use of a flag than can be preset by the customer or by a dynamic model of the customer's environment. Other possible filters include, but are not limited to: the sex of the driver of a taxi, such that female customers can hire taxis only driven by women; the name of the taxi firm, such that a passenger can choose to hire taxis only of their preferred firm. It will be appreciated that the server 116 may retain a customer profile which allows the application of a single filter criterion or, where defined in the customer profile, a number of filter criteria to be applied to the data relating to the taxis 102a-d such that only data relating to those taxis 102a-d which conform to the customer profile are transmitted to the mobile telephone 106.

The mobile telephone 106 displays the location of the taxis 102a-d on the display 122. Typically, the location of the taxis 102a-d is displayed on a map generated by a software application resident on the mobile telephone 106. Alternatively, or additionally, the location of the taxis 102a-d is displayed as an alphanumeric text list on the display 122.

The customer selects a taxi 102a-d and details of the taxi, for example taxi number, taxi firm & taxi capacity are displayed. The customer then selects which taxi they wish to hire and inputs a request for hire corresponding to their choice of taxi 102a-d via the user interface 124. Data corresponding to the customer's request for hire is transmitted to the base station 104 via the mobile telephone's transceiver. The base station 104 forwards this request for hire data to the taxi 102a-d indicated in the request for hire data. Typically, request data comprises the customer's name, location, and phone number. If the customer is not pre-registered with the system the request data may include the customer's payment details such that payment can be obtained in the event of a no-show or the customer not having sufficient cash to pay for their journey.

A notification corresponding to the request for hire data is displayed on the driver interface unit 112 of the taxi 102a-d requested by the customer. The driver of the taxi 102a-d can select to either accept or decline the customer's request via the driver interface unit 112. The acceptance or declination of the customer's request is transmitted to the base station 104 and if the driver has declined the customer's request notification data is transmitted to the mobile telephone 106, where a notice to this effect is output on the display 122, and the customer is requested to select another taxi 102a-d. Should the taxi driver accept the customer's request a notification to this effect is transmitted to the customer via their mobile telephone 106.

In some embodiments, the server 116 retains the customer's bank details and connects to an authorisation host 132 via a secure network 134 to authorise payment of either a pre-determined minimum fee, for example $5, or a pre-agreed fee for the whole journey, prior to sending the notification of acceptance to the customer. If payment is authorised the acceptance notification is sent to the customer and a notification of payment authorisation is sent to the driver via the driver interface unit 112. If payment is not authorised a notification of payment failure is sent to both the customer and the driver, and, in one embodiment, the driver can decide whether to accept or reject the customer as a cash only fare. In an alternative embodiment, the server 116 acts in response to receiving a failure of authorisation to prevent the driver of the selected taxi 102a-d from accepting the customer as a passenger in order to prevent the possibility of the customer being unable to pay the driver for their journey.

In an alternative embodiment, the payment authorisation step is carried out prior to the driver receiving notification of the customer's request for their taxi 102a-d. If the authorisation is declined the customer's request is not transmitted to the driver interface unit 112 and a notification that payment has been declined is forwarded to the customer's mobile phone 106.

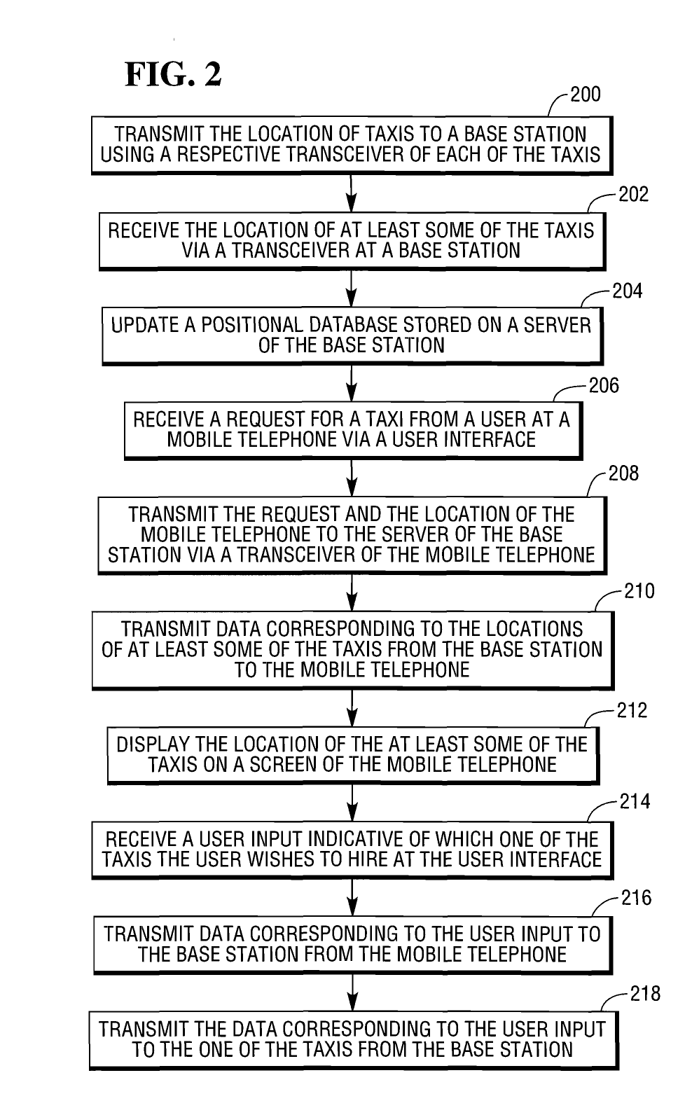

Referring now to FIG. 2, a method of transport allocation and payment comprises transmitting the location of taxis to a base station using a respective transceiver of each of the taxis (Step 200). The base station receives the location of at least one of the taxis via a transceiver (Step 202). A positional database stored on a server of the base station is updated (Step 204). A mobile telephone receives a request for transport from a user via a user interface (Step 206). The mobile telephone transmits the request and the location of the user device to the server of the base station. (Step 208). The base station transmits data corresponding to the locations of at least some of the plurality of vehicles to the user device (Step 210). A screen of the user device displays the location of the at least some of the taxis (Step 212). The user interface receives a user input indicative of which one of the taxis that the user wishes to hire (Step 214). The mobile telephone transmits data corresponding to the user input to the base station (Step 216). The base station transmits the data corresponding to the user input to the one of the taxis (Step 218).

It will be appreciated that the terms “usually”, “typically”, etc., as used herein are used in a non-exclusive sense, in so far as alternative or additional features to those described as usual or typical are envisaged.

It will be appreciated that although described with reference to a mobile telephone and suitable user activated device may be used, for example a personal computer, a personal digital assistant, an automated teller machine (ATM), vending kiosk or self check-in/check-out kiosk.

It will be further appreciated that although described with reference to taxis the present invention may be applied to any suitable mode of transport for hire.

It will also be appreciated that the steps of the methods described herein may be carried out in any suitable order, or simultaneously where appropriate. The methods described herein may be performed by software in machine readable form on a tangible storage medium or as a propagating signal.

Various modifications may be made to the above described embodiments without departing from the spirit and the scope of the invention.

1. A transport allocation and payment system comprising:
a plurality of vehicles, each comprising a positional locator and a transceiver;
a base station comprising a transceiver and a server;
a user device comprising a processor, a transceiver, a display and a user interface;
the positional locator of each vehicle being arranged to transmit the location of each vehicle to the base station using the vehicle's transceiver;
the base station being arranged to receive the location of each vehicle via the base station's transceiver and to update a positional database stored on the server;
the user device being arranged to receive a request for transport from a user via a user interface and to transmit said request and the location of the user device to the server of the base station via the user device's transceiver;
the base station being arranged to transmit data corresponding to the locations of at least some of the plurality of vehicles to the user device;
the user device being arranged to display the location of the at least some of the plurality of vehicles on the display;
the user interface being arranged to receive a user input indicative of which one of the at least some of the plurality of vehicles the user wishes to hire;
the user device being arranged to transmit data corresponding to the user input to the base station; and
the base station being arranged to transmit the data corresponding to the user input to the one of the plurality of vehicles.

2. The system of claim 1, wherein the base station comprises a database containing details of registered users of the system and is arranged to request authorisation of a payment from a user's account in response to receiving the data corresponding to the user input.

3. The system of claim 2, wherein the base station is arranged to prevent transmission of the data corresponding to the user input to the one of the plurality of vehicles if authorisation of the payment is refused.

4. The system of claim 1, wherein the base station is arranged to determine which of the plurality vehicles are located within a pre-determined distance of the location of the user device.

5. The system of claim 4, wherein the base station is arranged to transmit data corresponding to the location of only those of the plurality of vehicles which are located within the pre-determined distance to the user device.

6. The system of claim 1, wherein at least one of the plurality of vehicles comprises a driver interface unit arranged to display details of the user whom has selected said vehicle and arranged to receive a driver input either declining or accepting the user as a passenger.

7. The system of claim 1, wherein at least some of the plurality of vehicles are taxis.

8. A mobile device software application which when executed upon a processor of the mobile device causes the mobile device to operate as the user device of claim 1.

9. Base station software which when executed upon a processor of the base station causes the base station to operate as the base station of claim 1.

10. A mobile device arranged to operate as the user device of claim 1.

11. A vehicle hire base station arranged to operate as the base station of claim 1.

12. A mobile device software application arranged to generate and display a graphical user interface (GUI) on the user device of claim 1, wherein the GUI corresponds to the user interface of claim 1.

13. A method of transport allocation and payment comprising the steps of
transmitting the location of each of a plurality of vehicles to a base station using a respective transceiver of each of the plurality of vehicles;
receiving the location of at least one of the plurality of vehicles via a transceiver at a base station;
updating a positional database stored on a server of the base station;
receiving a request for transport from a user at a user device via a user interface;
transmitting the request and the location of the user device to the server of the base station via a transceiver of the user device;
transmitting data corresponding to the locations of at least some of the plurality of vehicles from the base station to the user device;
display the location of the at least some of the plurality of vehicles on a screen of the user device;
receiving a user input indicative of which one of the at least some of the plurality of vehicles the user wishes to hire at the user interface;
transmitting data corresponding to the user input to the base station from the user device; and
transmitting the data corresponding to the user input to the one of the plurality of vehicles from the base station.

14. The method of claim 13 comprising requesting authorisation of a payment from a user's account in response to receiving the data corresponding to the user input.

15. The method of claim 14 comprising preventing transmission of the data corresponding to the user input to the one of the plurality of vehicles from the base station if authorisation of the payment is refused.

16. The method of claim 13 comprising determining which of the plurality vehicles are located within a pre-determined distance of the location of the user device, at the base station and transmitting data corresponding to the location of only those of the plurality of vehicles which are located within the pre-determined distance to the user device from the base station.

17. The method of claim 13 comprising receiving a driver input either declining or accepting the user as a passenger at a driver interface unit and transmitting data corresponding to the driver input to the base station via the vehicle's transceiver.

18. The method of claim 17 comprising transmitting data corresponding to the driver input to the user device, where the contents of said data are displayed at the user interface.

19. The method of claim 17 comprising changing a status flag of said vehicle in response to the contents of the data corresponding to the driver input and transmitting data relating to only those of the plurality of vehicles which have a status flag corresponding to being available for hire from the base station to the user device.

20. The method of claim 13, wherein at least some of the plurality of vehicles are taxis.
